(19) United States
(12) Patent Application Publication
(10) Pub. No.: US 2026/0200406 A1
(43) Pub. Date: Jul. 16, 2026

(54) DISPLACEABLE VEHICLE STEP ASSEMBLY

(71) Applicant: LEGEND FLEET SOLUTIONS, Tillsonburg (CA)

(72) Inventors: Yorke Graham, Tillsonburg (CA); Ross Graham, Tillsonburg (CA)

(21) Appl. No.: 19/432,606

(22) Filed: Dec. 24, 2025

Related U.S. Application Data
(60) Provisional application No. 63/739,067, filed on Dec. 26, 2024.

(51) Int. Cl. B60R 3/02

(52) U.S. Cl. CPC B60R 3/02

(57) ABSTRACT

A displaceable vehicle step that has a step, a frame that can be mounted to the vehicle, and swing arms interconnecting the step to the frame. A biasing mechanism is mounted adjacent to a cover plate with a second slot. A control interconnects the swing arms and the biasing mechanism. A cam follower having first and second ends operatively interconnects the cover plate with the biasing mechanism. A detent plate is mounted to the control cover plate and receives a first end of the cam follower; the second end of the cam follower is interconnected to the biasing mechanism. The detent plate includes a first slot and at least one spring-loaded detent. When the cam follower is past the detent, the detent springs out to hold the said cam follower in place, which then holds the step in its normal position. In the event an obstruction is engaged, the detent is forced to retract allowing the cam follower to move within the first slot which allows the step to pivot with respect to said frame.

### CROSS-REFERENCE TO RELATED APPLICATIONS

This application claims the benefit of U.S. Provisional Application No. 63/739,067 filed on Dec. 26, 2024, which is incorporated herein by reference in its entirety.

### TECHNICAL FIELD

This invention relates generally to vehicle steps and more particularly to vehicle steps that are displaceable from a normal position to a second position upon impact.

### BACKGROUND OF THE INVENTION

Vehicles, particularly those that are raised higher off the ground, like pickup or delivery trucks, use steps to help with entering the vehicle. These steps are usually mounted to the frame near the doors. They can come in various shapes, ranging from a flat surface to a flat surface with sides or a round tube, for example. The problem with these steps is that they are typically fixed. If an obstruction is hit, the steps are damaged and need to be replaced.

It is desirable to provide a step that will displace, or move out of the way upon impact with a structure and snap back when the obstruction is removed.

### SUMMARY OF THE INVENTION

In general terms, this invention provides a displaceable vehicle step that has a step, a frame that can be mounted to the vehicle, and swing arms interconnecting the step to the frame. The swing arms include a swing arm body section, a first pivot shaft, and a second pivot shaft. A third pivot shaft is mounted to the step to connect the step to the swing arms. A fourth pivot shaft interconnects the swing arms to the step.

A biasing mechanism is mounted adjacent to a cover plate with a second slot. A control interconnects the swing arms and the biasing mechanism. A cam follower having first and second ends operatively interconnects the cover plate with the biasing mechanism.

A detent plate is mounted to the control cover plate and receives a first end of the cam follower, the second end of the cam follower is interconnected to the biasing mechanism.

The detent plate includes a first slot and at least one spring-loaded detent. When the cam follower is past the detent, the detent springs out to hold the cam follower in place, which then holds the step in its normal position. In the event an obstruction is engaged, the detent is forced to retract allowing the cam follower to move within the first slot which allows the step to pivot with respect to the frame. As the cam follower moves within slot, it is also moving within the second slot in the cover plate. The first slot and said second are at right angles to one another, allowing for free pivotal movement of the step with respect to the frame and linear movement of the cam follower and biasing mechanism.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the displaceable vehicle step of the present invention.

FIG. 2 is a perspective view of the frame.

FIG. 3 includes a perspective view of the swing arms, top side (FIG. 3a), bottom side (FIG. 3b), and end view (FIG. 3c) of the swing arms.

FIG. 4 is a top view of the displaceable vehicle step.

FIG. 4A is a cross-section A-A of FIG. 4.

FIG. 4B is a cross-section C-C of FIG. 4.

FIG. 4C is a cross-section B-B of FIG. 4.

FIG. 5 is a detail view of D as shown in FIG. 4B.

FIG. 6 is a detail view of G as shown in FIG. 4C.

FIG. 7 is a detail view of B as shown in FIG. 4A.

FIG. 8 is a perspective top end and side view of the detent plate.

FIG. 8A is a side view of FIG. 8.

FIG. 8B is a perspective view of FIG. 8.

FIG. 9 is exploded perspective view of the biasing mechanism.

FIG. 10 is a top view of the biasing mechanism.

FIG. 10 A is a side and end view of the biasing mechanism.

FIG. 10 B is an end view of the biasing mechanism.

FIG. 11 is a cutaway view of the biasing mechanism.

FIG. 12 is a cutaway side view of the displaceable vehicle step.

### DETAILED DESCRIPTION OF A PREFERRED EMBODIMENT

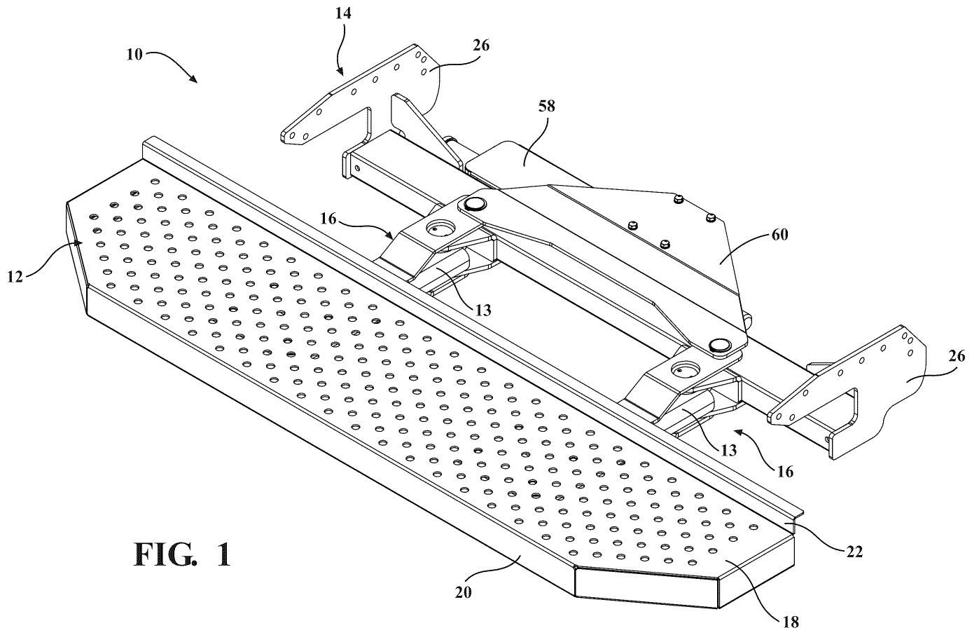

With reference to FIG. 1, the displaceable vehicle step of the present invention is shown generally at 10. The displaceable step 10 includes a step 12, a frame 14, and swing arms 16 interconnecting the step 12 to the frame 14.

The step 12 as illustrated has a top surface 18, side members 20, and a back lip 22. It will be appreciated by those of ordinary skill in the art that the step could take numerous different geometric shapes. For example, it could be a single plate surface, it could be a round tube, it could be a series of tubes, etc.

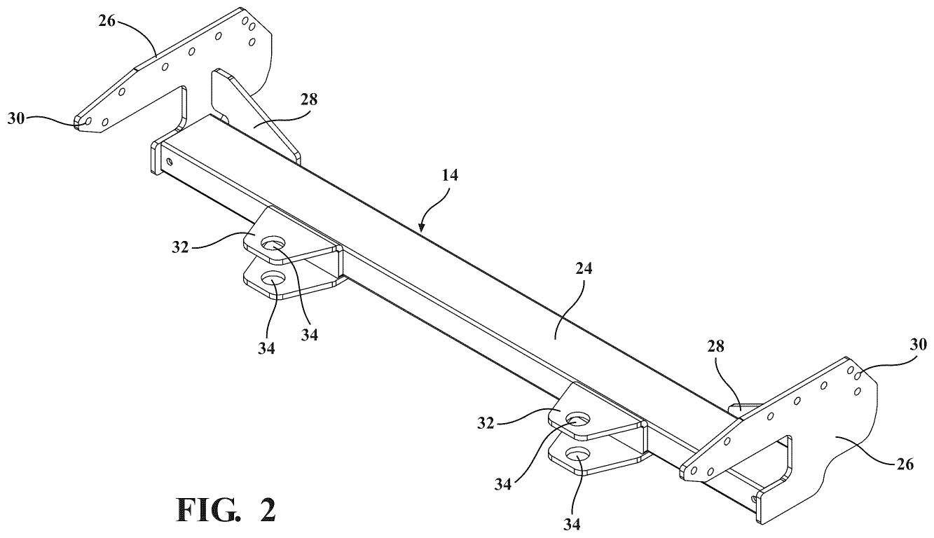

The frame of 14, which is shown in greater detail in FIG. 2, includes a body section 24 which as shown has a square metal tube, but could be of other shapes, including round, oval, rectangular, etc. Attachment brackets 26 are mounted to the opposed ends of the metal tube 24. Braces 28 are shown interconnecting the attachment brackets 26 to the body section 24. As will be appreciated, these may or may not be needed. The attachment brackets have holes 30 for connecting the displaceable vehicle step 10 to a vehicle. As will be appreciated by those of ordinary skill in the art, other types of mounting brackets could be used for attaching displaceable vehicle step 10 to a vehicle.

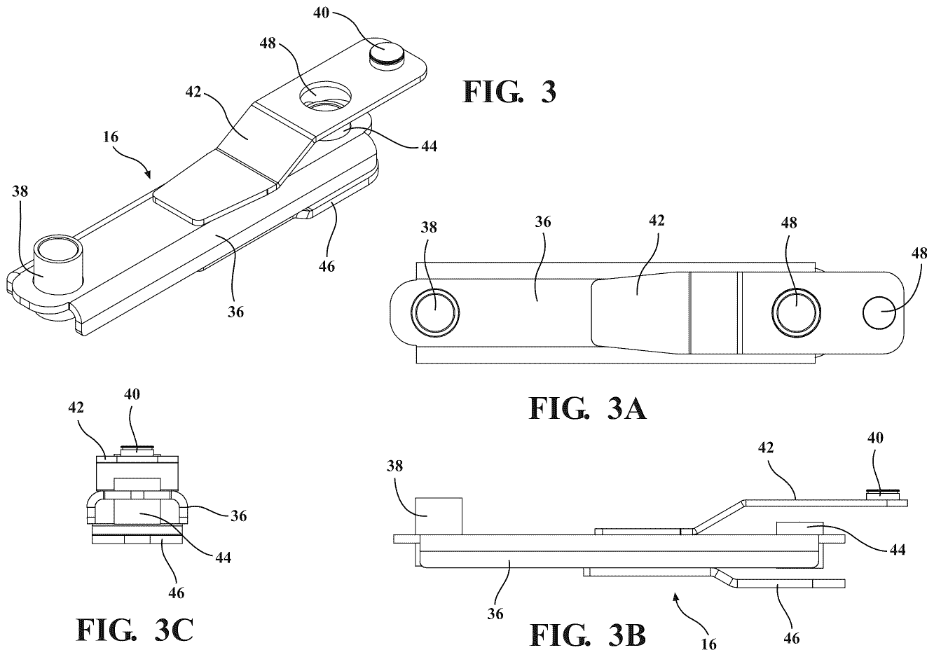

The frame 14 includes swing arm mounts 32 or double flange split bearings 32, with openings 34. The swing arm mounts 32 receive the swing arms 16 for pivotally connecting the step 12 to the frame 14. As will be appreciated by those of ordinary skill in the art, the swing arm mounts 32 allow the swing arms 16 to pivot with respect to the frame 14 in the event an obstruction is engaged by the step 12. The step 12 is able to move generally parallel to the frame 14 in the event it contacts an obstruction. With reference to FIG. 3, the swing arms 16 include a swing arm body section 36, a first pivot shaft 38, and a second pivot shaft 40. The second pivot shaft 40 is elevated with respect to the body section 36 by a raised finger section 42. This can best be seen in FIG. 3 as well as FIG. 3B. The raised finger section 42 also includes an opening 48 which is spaced from and adjacent to second pivot shaft 40. The body section 36 also includes a sleeve bearing 44 below the opening 48 and a lower finger section 46.

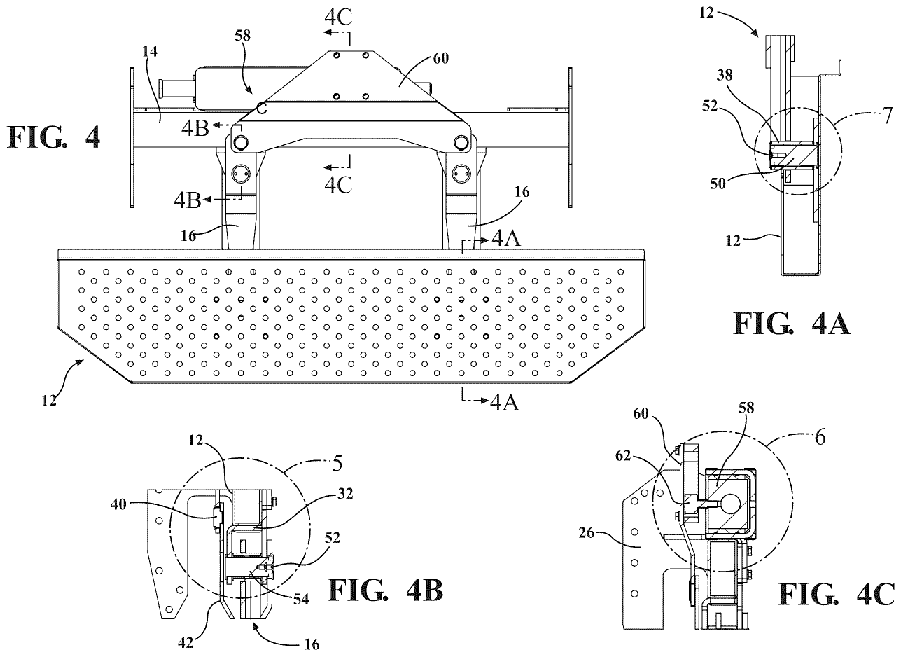

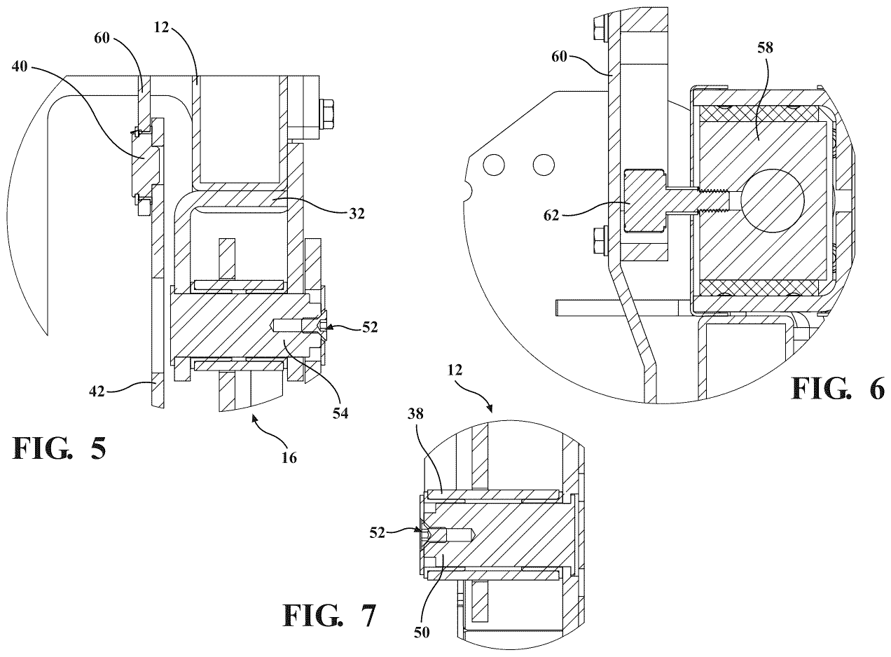

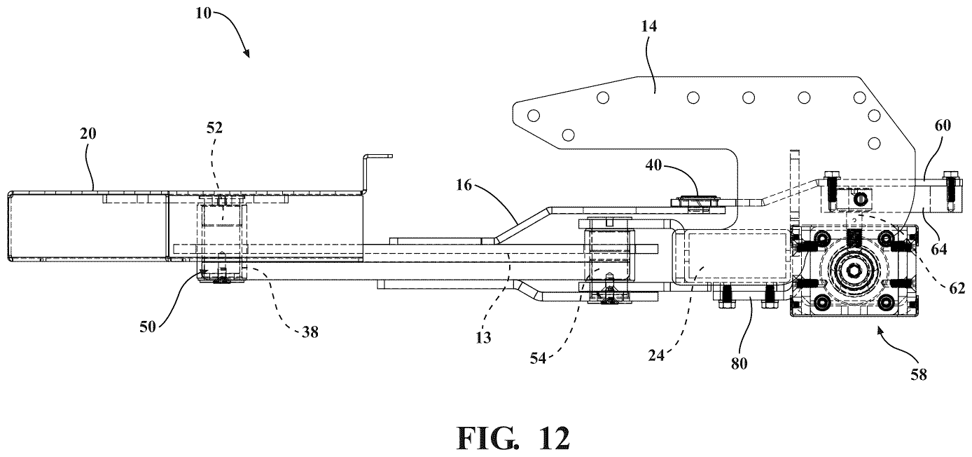

With reference to FIGS. 4, 5, 6, and 7, the interconnection and action of the displaceable vehicle step 10 will be further described. With reference to FIG. 7, there is a third pivot shaft 50 which is mounted to the step 12. This can also be seen in FIG. 12. The third pivot shaft receives a sleeve bearing with flange 52 which then is received by the first pivot shaft 38 to connect the swing arms 16 to the frame 14.

With reference to FIG. 12, a fourth pivot shaft 54 is shown. The fourth pivot shaft 54 interconnects the swing arms 16 to the step 12. The step 12 has legs 13 extending from the step 12. This connection also includes a swing bearing with a flange 52, similar to that shown in FIG. 7 with regard to the third pivot shaft 50.

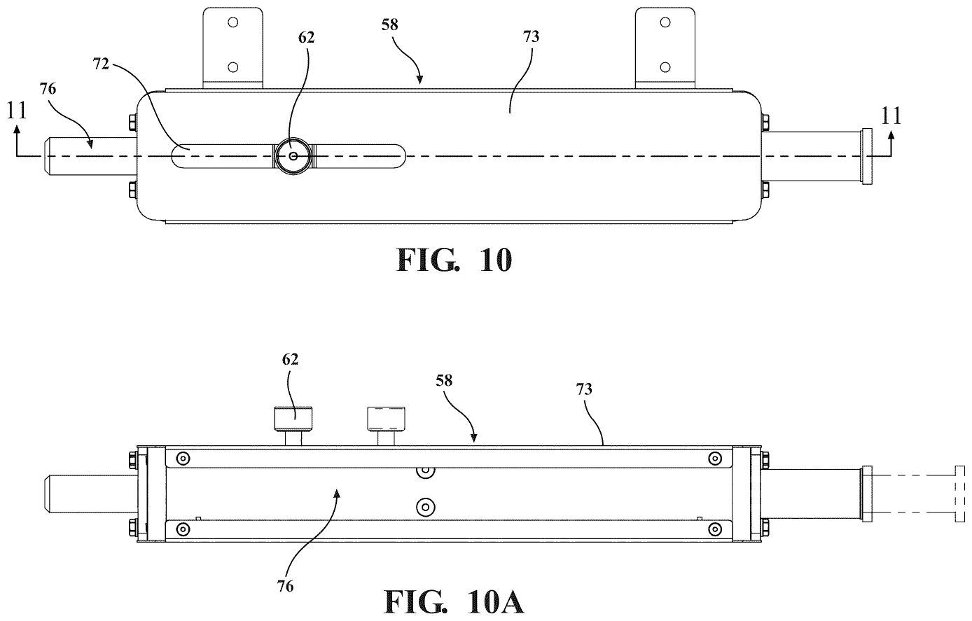

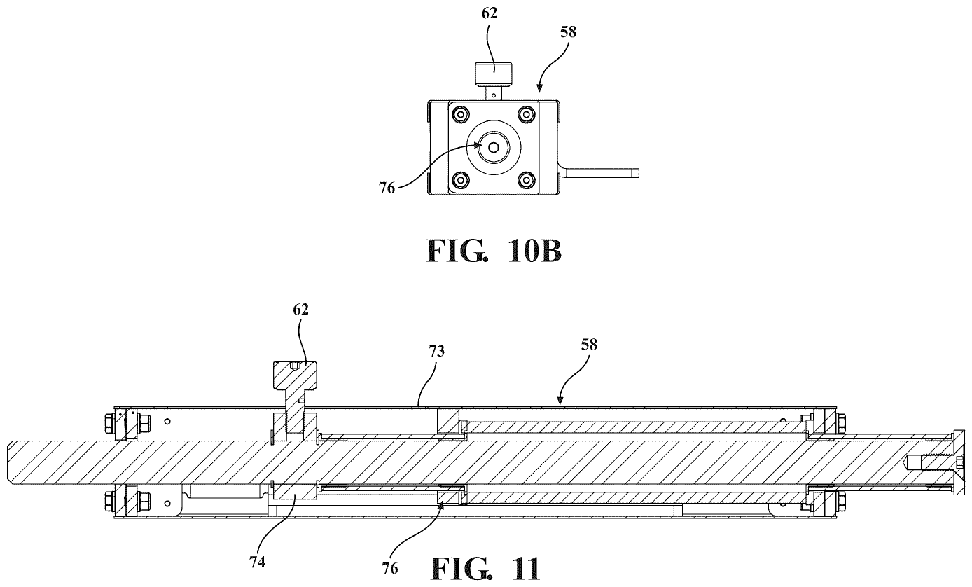

With reference to the drawings, and in particular FIGS. 1, 9, 10, and 12, the displaceable vehicle step 10 of the present invention also includes a biasing mechanism 58. The biasing mechanism as illustrated is a two-way spring-loaded cylinder, but could be a two-way hydraulic cylinder or any other biasing means, not necessarily having to be a cylinder but could be just spring-loaded rods, etc. With reference to the figures, and in particular FIGS. 1, 4 and 6, a control 60 interconnects the swing arms 16 and the biasing mechanism 58. The interconnecting of these elements provides a bias to the step 12 to ensure that step 12 always returns to its initial position. This will be discussed in greater detail below. However, it is important to appreciate that in the event the step 12 engages an obstruction, it is free to pivot with respect to the frame 14, and once the obstruction has been cleared, the step 12 springs back to its original location for use. This spring or biasing action is through the interconnection of the biasing mechanism 58 and the control cover plate 60, and arms 16.

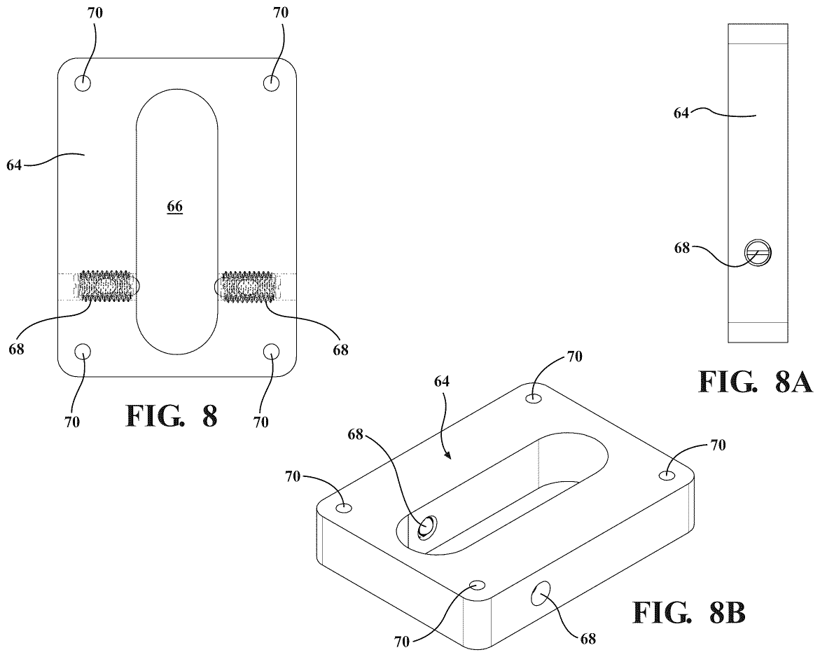

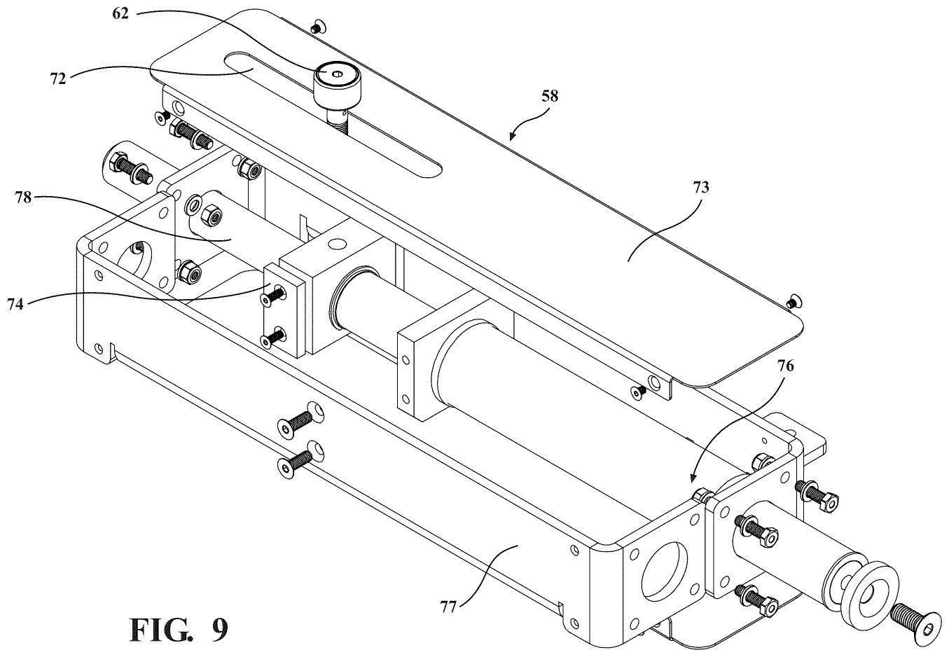

With reference to FIGS. 6 and 8-12, the interaction and operation of the biasing mechanism, control plate, and step frame will be discussed. With reference to FIG. 9 as well as FIGS. 6 and 8, a cam follower 62 operatively interconnects the cover plate 60 with the biasing mechanism 58. A detent plate 64, as shown in FIG. 8 is mounted to the control cover plate 60 and receives the head of the cam follower 62. The opposite end of the cam follower is received within a slot 72 in cover plate 73 which covers the housing 77 in which the biasing mechanism 58 is housed. The detent plate 64 includes a slot 66 and at least one, but what is shown are two spring-loaded detents 62. As shown in this embodiment, there are holes 70 for receiving fasteners to interconnect the detent plate 64 to the control cover plate 60.

The detent plate 64 receives the head of the cam follower 62. When the cam follower is past the detent 68, the detents 68 spring out to hold the cam follower 62 in place which then holds the step 12 in its normal position. In the event an obstruction is engaged, the spring-loaded detents 68 are forced to retract allowing the cam follower 62 to move within slot 66. This movement allows the step 12 to pivot with respect to the vehicle or frame 14. As the cam follower 62 moves within slot 66, it is also moving within slot 72 in the cylinder cover plate 73. These slots 66 and 72 are at right angles to one another allowing for free pivotal movement of the step 12 with respect to frame 14 and linear movement of the cam follower 62 and biasing mechanism 58.

The cam follower 62 is interconnected to an anti-rotation pad 74 mounted to the biasing mechanism 58. As shown, the biasing mechanism 58 has a guide tube 76 and a rod 78 that moves against a spring bias within guide tube 76, or as will appreciated by those of ordinary skill in the art, a hydraulic bias if so desired.

As shown in FIG. 12, the biasing mechanism 58 can be mounted through an attachment bracket 80 to the frame 14. In this way, the displaceable vehicle step can be a single unit which is easily mounted to a vehicle through brackets 26. As discussed above, in the event an obstruction is encountered, the step 12 can pivot with respect to the frame 14 to clear the obstruction, and once clear of the obstruction, spring back through the bias of biasing mechanism 58 to its original position. This original position being maintained through the detents 68 engaging the cam follower 62 within the detent plate 64.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A displaceable vehicle step comprising
a step 12;
a frame 14, and
swing arms 16 interconnecting said step 12 to the frame 14;
said swing arms 16 include a swing arm body section 36, a first pivot shaft 38, and a second pivot shaft 40;
a third pivot shaft 50 is mounted to the step 12 to interconnect the step 12 to the frame 14.
a fourth pivot shaft 54 interconnects the swing arms 16 to the step 12;
a biasing mechanism 58 mounted adjacent to a cover plate 73 with a second slot 72;
a control 60 interconnects the swing arms 16 and the biasing mechanism 58;
a cam follower 62 having first and second ends operatively interconnects the cover plate 60 with the biasing mechanism 58;
a detent plate 64, is mounted to the control cover plate 60 and receives a first end of said cam follower 62, the second end of said cam follower 62 is interconnected to said biasing mechanism 58;
said detent plate 64 includes a first slot 66 and at least one, spring-loaded detent 62;
when said cam follower is past said detent 68, said detent 68 springs out to hold the said cam follower 62 in place which then holds said step 12 in its normal position, in the event an obstruction is engaged, said detent 68 is forced to retract allowing the cam follower 62 to move within said first slot 66 which allows said step 12 to pivot with respect to said frame 14, as the cam follower 62 moves within slot 66, it is also moving within said second slot 72 in said cover plate 73, said first slot 66 and said second 72 are at right angles to one another, allowing for free pivotal movement of said step 12 with respect to frame 14 and linear movement of said cam follower 62 and biasing mechanism 58.

2. The displaceable vehicle step of claim 1, wherein said second pivot shaft 40 is elevated with respect to the body section 36 by a raised finger section 42, said raised finger section 42 also includes an opening 48 which is spaced from and adjacent to second pivot shaft 40.

3. The displaceable vehicle step of claim 2, wherein said body section 36 includes a sleeve bearing 44 below said opening 48 and a lower finger section 46.

4. The displaceable vehicle step of claim 1, wherein said step includes a top surface 18, side members 20, and a back lip 22.

5. The displaceable vehicle step of claim 1, wherein said frame 14 includes a body section 24, attachment brackets 26 are mounted to the opposed ends of body section 24.

6. The displaceable vehicle step of claim 1, wherein said frame 14 includes swing arm mounts 32 configured to receive the swing arms 16 for pivotally connecting the step 12 to the frame 14; whereby said swing arm mounts 32 are configured to allow said swing arms 16 to move generally parallel to the frame 14 in the event an obstruction is engaged by said step 12.

7. The displaceable vehicle step of claim 1, further including a housing 77, said housing 77 houses said biasing mechanism 58, said cover plate 73 is mounted to said housing 77.

8. The displaceable vehicle step of claim 1, wherein said biasing mechanism includes a guide tube 76 and a rod 78 that moves against a spring bias within guide tube 76.

9. The displaceable vehicle step of claim 1, further including an anti-rotation pad 74 mounted to the biasing mechanism 58, said cam follower 62 is interconnected to said anti-rotation pad 74.

10. A displaceable vehicle step comprising:
a step 12;
a frame 14, and
swing arms 16 interconnecting said step 12 to the frame 14;
a biasing mechanism 58 mounted adjacent to a cover plate 73 with a second slot 72;
a control 60 interconnects the swing arms 16 and the biasing mechanism 58;
a cam follower 62 having first and second ends operatively interconnects the cover plate 60 with the biasing mechanism 58;
a detent plate 64, is mounted to the control cover plate 60 and receives a first end of said cam follower 62, the second end of said cam follower 62 is interconnected to said biasing mechanism 58;
said detent plate 64 includes a first slot 66 and at least one, spring-loaded detent 62;
when said cam follower is past said detent 68, said detent 68 springs out to hold the said cam follower 62 in place which then holds said step 12 in its normal position, in the event an obstruction is engaged, said detent 68 is forced to retract allowing the cam follower 62 to move within said first slot 66 which allows said step 12 to pivot with respect to said frame 14, as the cam follower 62 moves within slot 66, it is also moving within said second slot 72 in said cover plate 73, said first slot 66 and said second 72 are at right angles to one another, allowing for free pivotal movement of said step 12 with respect to frame 14 and linear movement of said cam follower 62 and biasing mechanism 58.

11. The displaceable vehicle step of claim 10, wherein said swing arms 16 include a swing arm body section 36, a first pivot shaft 38, and a second pivot shaft 40; a third pivot shaft 50 is mounted to the step 12 to interconnect the step 12 to the frame 14; a fourth pivot shaft 54 interconnects the swing arms 16 to the step 12.

12. The displaceable vehicle step of claim 11, wherein said second pivot shaft 40 is elevated with respect to the body section 36 by a raised finger section 42 said raised finger section 42 also includes an opening 48 which is spaced from and adjacent to second pivot shaft 40.

13. The displaceable vehicle step of claim 11, wherein said body section 36 includes a sleeve bearing 44 below said opening 48 and a lower finger section 46.

14. The displaceable vehicle step of claim 8, wherein said step includes a top surface 18, side members 20, and a back lip 22.

15. The displaceable vehicle step of claim 10, wherein said frame 14 includes a body section 24, attachment brackets 26 are mounted to the opposed ends of body section 24.

16. The displaceable vehicle step of claim 10, wherein said frame 14 includes swing arm mounts 32 configured to receive the swing arms 16 for pivotally connecting the step 12 to the frame 14; whereby said swing arm mounts 32 are configured to allow said swing arms 16 to move generally parallel to the frame 14 in the event an obstruction is engaged by said step 12.

17. The displaceable vehicle step of claim 10, further including a housing 77 housing said biasing mechanism 58, said cover plate 73 is mounted to said housing 77.

18. The displaceable vehicle step of claim 10, wherein said biasing mechanism includes a guide tube 76 and a rod 78 that moves against a spring bias within guide tube 76.

19. The displaceable vehicle step of claim 10, further including an anti-rotation pad 74 mounted to the biasing mechanism 58, said cam follower 62 is interconnected to said anti-rotation pad 74.
